(19) United States
(12) Patent Application Publication
(10) Pub. No.: US 2021/0089133 A1
(43) Pub. Date: Mar. 25, 2021

(54) GESTURE DETECTION SYSTEM

(71) Applicant: Sentons Inc., Grand Cayman (KY)

(72) Inventors: Samuel W. Sheng, Saratoga, CA (US); Robert Drew Tausworthe, Saratoga, CA (US); Alan Kamas, Sunnyvale, CA (US)

(21) Appl. No.: 17/030,227

(22) Filed: Sep. 23, 2020

Related U.S. Application Data
(60) Provisional application No. 62/906,052, filed on Sep. 25, 2019.

(51) Int. Cl. G06F 3/01; G06F 3/041

(52) U.S. Cl. CPC G06F 3/017; G06F 2203/04105; G06F 3/016; G06F 3/0412

(57) ABSTRACT

A system including sensors and a processor is described. The sensors are configured to sense force. The processor receives force measurements from the sensors. The force measurements correspond to touch locations. The processor is also configured to detect a gesture based on the force measurements and the touch locations and to provide at least one signal indicating an identification of the gesture.

### CROSS REFERENCE TO OTHER APPLICATIONS

This application claims priority to U.S. Provisional Patent Application No. 62/906,052 entitled GESTURE PROCESSOR filed Sep. 25, 2019 which is incorporated herein by reference for all purposes.

### BACKGROUND OF THE INVENTION

Electronic devices such as smartphones, tablet computers, and wearables typically include a metal and/or plastic housing to provide protection and structure to the devices. The housing often includes openings to accommodate physical buttons that are utilized to interface with the device. However, there is a limit to the number and types of physical buttons that are able to be included in some devices due to physical, structural, and usability constraints. For example, physical buttons may consume too much valuable internal device space and provide pathways where water and dirt may enter a device to cause damage. Consequently, other mechanisms for allowing a user to interacting with electronic devices are desired.

### BRIEF DESCRIPTION OF THE DRAWINGS

Various embodiments of the invention are disclosed in the following detailed description and the accompanying drawings.

FIG. 1 is a schematic diagram illustrating an embodiment of a piezoresistive bridge structure usable as a strain sensor.

FIG. 2 depicts an embodiment of an integrated sensor.

FIGS. 3A-3B are block diagrams illustrating an embodiment of a system for detecting a touch inputs and utilizing touch inputs for gesture detection.

FIG. 4 is a diagram depicting an embodiment of a device utilizing force and touch sensors for performing touch input detection and utilizing touch inputs for providing user interface elements.

FIG. 5 is a diagram depicting an embodiment of a device utilizing force and touch sensors for performing touch input detection and utilizing touch inputs for providing user interface elements.

FIG. 6 is a diagram depicting an embodiment of a device utilizing force and touch sensors for performing touch input detection and utilizing touch inputs for providing user interface elements.

FIG. 7 is a flow chart depicting an embodiment of a method for detecting gestures using touch inputs.

FIG. 8 is a flow chart depicting an embodiment of a method for detecting gestures using touch inputs.

FIG. 9 is a flow chart depicting an embodiment of a method for detecting gestures using additional inputs.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The housing for electronic devices provides structure and protection to the components therein and typically includes openings to accommodate physical buttons used to control the device. However, such physical buttons consume valuable device spaces, provide pathways for contaminants to enter the device and have fixed locations. Consequently, other mechanisms for interfacing with an electronic device such as a mobile phone (e.g. a smartphone), a tablet, and/or a wearable are desired.

Touch surfaces are increasing utilized in displays of computer devices. Such touch surfaces can be used to interact with the device. For example, the touch surface may be part of a display for a cell phone or smart phone, a wearable, a tablet, a laptop, a television etc. Various technologies have been traditionally used to detect a touch input on such a display. For example, capacitive and resistive touch detection technology may be used. Using resistive touch technology, often a glass panel is coated with multiple conductive layers that register touches when physical pressure is applied to the layers to force the layers to make physical contact. Using capacitive touch technology, often a glass panel is coated with material that can hold an electrical charge sensitive to a human finger. By detecting the change in the electrical charge due to a touch, a touch location can be detected. However, with resistive and capacitive touch detection technologies, the glass screen is required to be coated with a material that reduces the clarity of the glass screen. Additionally, because the entire glass screen is required to be coated with a material, manufacturing and component costs can become prohibitively expensive as larger screens are desired. Capacitive touch surface technologies also may face significant issues in use with metal (i.e. conductive) and/or curved surfaces. This limitation may restrict capacitive touch surfaces to smaller, flat displays. Thus, traditional touch surfaces may be limited in utility.

Electrical components can be used to detect a physical disturbance (e.g., strain, force, pressure, vibration, etc.). Such a component may detect expansion of or pressure on a particular region on a device and provide an output signal in response. Such components may be utilized in devices to detect a touch. For example, a component mounted on a portion of the smartphone may detect an expansion or flexing of the portion to which the component is mounted and provide an output signal. The output signal from the component can be considered to indicate a purposeful touch (a touch input) of the smartphone by the user. Such electrical components may not be limited to the display of the electronic device.

However, a smartphone or other device may undergo flexing and/or localized pressure increases for reasons not related to a user's touch. Thus, purposeful touches by a user (touch inputs) are desired to be distinguished from other physical input, such as bending of the device and environmental factors that can affect the characteristics of the device, such as temperature. In some embodiments, therefore, a touch input includes touches by the user, but excludes bending and/or temperature effects. For example, a swipe or press of a particular region of a mobile phone is desired to be detected as a touch input, while a user sitting on the phone or a rapid change in temperature of the mobile phone should not to be determined to be a touch input.

Further, even if touch inputs may be accurately detected, system latency may suffer. For example, a touch may be readily detected on a display utilizing the technology described above. In response to the touch, it is generally desirable to provide feedback to the user, including but not limited to haptic feedback. Once a touch is identified, the information related to the touch is often provided to the application system (e.g. the operating system and/or central processing unit) for the device. The device can then update the user interface and/or provide a control signal to a haptics system. Based on the control signal, the haptics system activates haptics actuators to provide haptic feedback. In the case of a gesture, such as a movement corresponding of an indicator on a slide bar, the process is even more complex. The information related to the touch(es) is processed by the application system. The gesture (e.g. the slide) may then be recognized by the application system. The application system then activates the haptics system to generate the haptic feedback. Although this system functions, there may be a significant delay between the user's gesture and the haptic feedback. For example, the delay may be two hundred milliseconds or more in some cases. For many applications, such as gaming, such a delay is unacceptable for users. Consequently, the ability of the system to provide haptic feedback is adversely affected.

A system usable in detecting gestures and, in some embodiments, generating haptic feedback, is described. The system includes sensors and a processor. The sensors are configured to sense force. For example, the sensors may include force and/or touch sensors. The processor receives force measurements from the sensors. The force measurements correspond to touch locations. The processor detects a gesture based on the force measurements and the touch locations. The processor is also configured to provide signal(s) indicating an identification of the gesture. In some embodiments, the processor also receives a gesture configuration identifying characteristics for the gesture. The characteristics may include a force, a touch location, a speed, and/or a pattern of touch locations. For example, the force could include a force threshold and/or a rate of change of force threshold. The touch location may include locations defining region(s) of the touch surface(s). The speed may include an absolute speed threshold and/or a relative speed threshold. The pattern of touch locations may include a geometric shape and a direction across at least a portion of the touch surface(s). Thus, the system may not only detect gestures but provide haptic feedback to a user with a reduced latency. As such, performance of the device incorporating the system may be improved.

In some embodiments, the system also includes at least one haptics generator. In such embodiments, the processor provides the signal(s) identifying the gesture to haptics generator(s). The processor may also provide the signal(s) to an applications system of a device incorporating the processor. Thus, the device may otherwise utilize the identification of the gesture.

In some embodiments, the processor is further configured to receive external input(s). For example, the processor may receive an accelerometer input. In some such embodiments, the processor further pauses detection of the gesture based upon the accelerometer input indicating free fall. Thus, the processor may also aid in protecting the haptics system and/or other portions of the device from damage due to a fall.

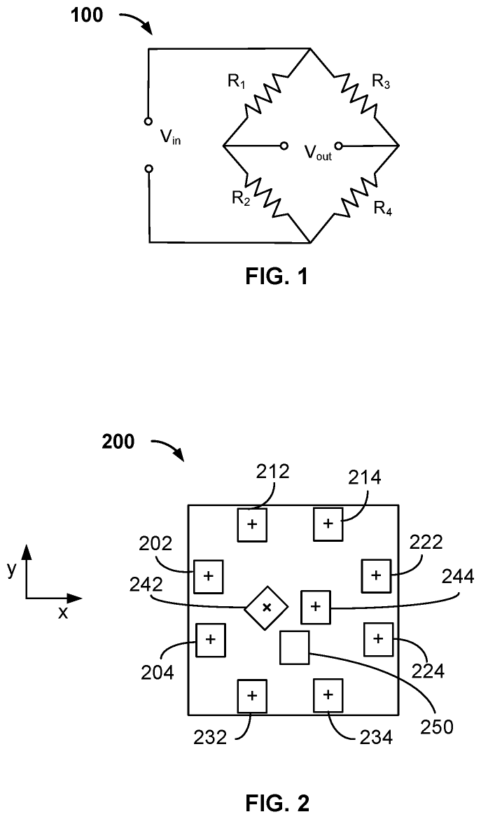

FIG. 1A is a schematic diagram illustrating an embodiment of a piezoresistive bridge structure that can be utilized as a strain sensor. Piezoresistive bridge structure 100 includes four piezoresistive elements that are connected together as two parallel paths of two piezoresistive elements in series (e.g., Wheatstone Bridge configuration). Each parallel path acts as a separate voltage divider. The same supply voltage (e.g., Vᵢₙ of FIG. 1) is applied to both of the parallel paths. By measuring a voltage difference (e.g., Vₒᵤₜ of FIG. 1) between a mid-point at one of the parallel paths (e.g., between piezoresistive elements R₁ and R₂ in series as shown in FIG. 1) and a mid-point of the other parallel path (e.g., between piezoresistive elements R₃ and R₄ in series as shown in FIG. 1), a magnitude of a physical disturbance (e.g. strain) applied on the piezoresistive structure can be detected.

In some embodiments, rather than individually attaching separate already manufactured piezoresistive elements together on to a backing material to produce the piezoresistive bridge structure, the piezoresistive bridge structure is manufactured together as a single integrated circuit component and included in an application-specific integrated circuit (ASIC) chip. For example, the four piezoresistive elements and appropriate connections between are fabricated on the same silicon wafer/substrate using a photolithography microfabrication process. In an alternative embodiment, the piezoresistive bridge structure is built using a microelectromechanical systems (MEMS) process. The piezoresistive elements may be any mobility sensitive/dependent element (e.g., as a resistor, a transistor, etc.).

FIG. 2 is a block diagram depicting an embodiment of integrated sensor 200 that can be used to sense forces (e.g. a force sensor). In particular, forces input to a device may result in flexing of, expansion of, or other physical disturbance in the device. Such physical disturbances may be sensed by force sensors. Integrated sensor 200 includes multiple strain sensors 202, 204, 212, 214, 222, 224, 232, 234, 242 and 244. Each strain sensor 202, 204, 212, 214, 222, 224, 232, 234, 242 and 244 may be a piezoresistive element such as piezoresistive element 100. In other embodiments, another strain measurement device might be used. Strain sensors 202, 204, 212, 214, 222, 224, 232, 234, 242 and 244 may be fabricated on the same substrate. Multiple integrated sensors 200 may also be fabricated on the same substrate and then singulated for use. Integrated sensor 200 may be small, for example five millimeters by five millimeters (in the x and y directions) or less.

Each strain sensor 202, 204, 212, 214, 222, 224, 232, 234, 242 and 244 is labeled with a + sign indicating the directions of strain sensed. Thus, strain sensors 202, 204, 212, 214, 222, 224, 232, 234 and 244 sense strains (expansion or contraction) in the x and y directions. However, strain sensors at the edges of integrated sensor 200 may be considered to sense strains in a single direction. This is because there is no expansion or contraction beyond the edge of integrated sensor 200. Thus, strain sensors 202 and 204 and strain sensors 222 and 224 measure strains parallel to the y-axis, while strain sensors 212 and 214 and strain sensors 232 and 234 sense strains parallel to the x-axis. Strain sensor 242 has been configured in a different direction. Strain sensor 242 measures strains in the xy direction (parallel to the lines x=y or x=−y). For example, strain sensor 242 may be used to sense twists of integrated sensor 200. In some embodiments, the output of strain sensor 242 is small or negligible in the absence of a twist to integrated sensor 200 or the surface to which integrated sensor 200 is mounted.

Thus, integrated sensor 200 obtains ten measurements of strain: four measurements of strain in the y direction from strain sensors 202, 204, 222 and 224; four measurements of strain in the x direction from sensors 212, 214, 232 and 234; one measurement of strains in the xy direction from sensors 242 and one measurement of strain from sensor 244. Although ten strain measurements are received from strain sensors 202, 204, 212, 214, 222, 224, 232, 234, 242 and 244, six measurements may be considered independent. Strain sensors 202, 204, 212, 214, 222, 224, 232, and 234 on the edges may be considered to provide four independent measurements of strain. In other embodiments, a different number of strain sensors and/or different locations for strain sensors may be used in integrated sensor 200.

Integrated sensor 200 also includes temperature sensor 250 in some embodiments. Temperature sensor 250 provide an onboard measurement of the temperatures to which strain sensors 202, 204, 212, 214, 222, 224, 232, 234, 242 and 244 are exposed. Thus, temperature sensor 200 may be used to account for drift and other temperature artifacts that may be present in strain data. Integrated sensor 200 may be used in a device for detecting touch inputs.

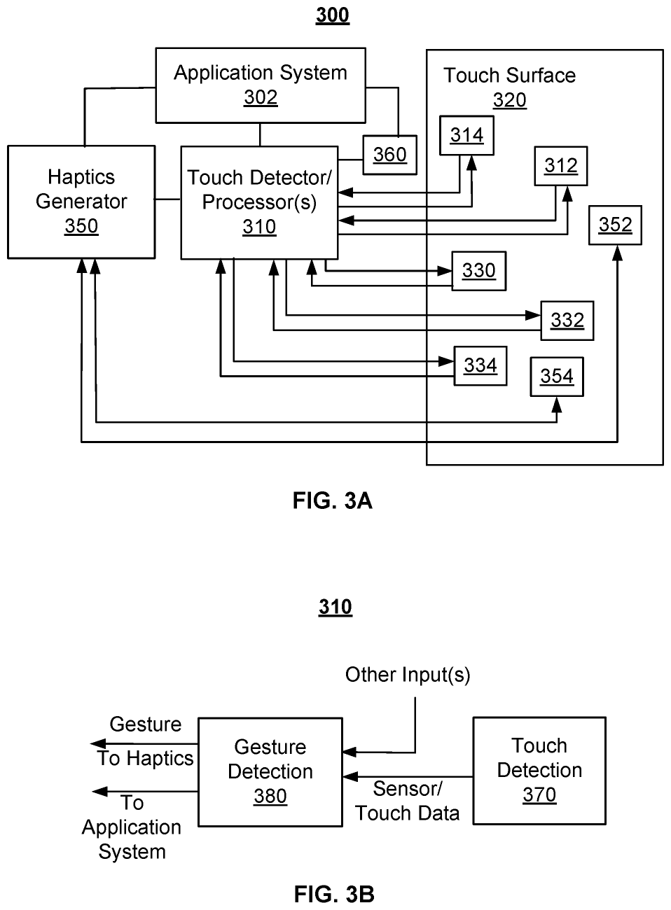

FIGS. 3A-3B are block diagrams illustrating an embodiment of system 300 for detecting and utilizing touch inputs. FIG. 3A depicts system 300. System 300 may be considered part of a device that can be interacted with via touch inputs. Thus, system 300 may be part of a kiosk, an ATM, a computing device, an entertainment device, a digital signage apparatus, a mobile phone (e.g. a smartphone), a tablet computer, a point of sale terminal, a food and restaurant apparatus, a gaming device, a casino game and application, a piece of furniture, a vehicle, an industrial application, a financial application, a medical device, an appliance, and any other objects or devices having surfaces for which a touch input is desired to be detected (“touch surfaces”). Furthermore, the surfaces from which a touch input may be detected are not limited displays. Instead, metal and other surfaces, such as a housing or cover, and curved surfaces, such as a device side or edge, may be used as touch surfaces.

System 300 is connected with application system 302 and touch surface 320, which may be considered part of the device with which system 300 is used. System 300 includes touch detector/processor(s) 310, force sensors 312 and 314, transmitter 330 and touch sensors 332 and 334. Also shown are optional haptics generator 350, haptics actuators 352 and 354, and additional sensor(s) 360. Although indicated as part of touch surface 320, haptics actuators 352 and 354 may be located elsewhere on the device incorporating system 300. Additional sensor(s) 360 may include orientation sensors such as accelerometer(s), gyroscope(s) and/or other sensors generally included in a device, such as a smartphone. Although shown as not located on touch surface 320, additional sensor(s) 360 may be at or near touch surface 320. Although shown as coupled with touch detector/processor(s) 310, in some embodiments, sensor(s) 360 and/or haptics generator 350 are simply coupled with application system 302. Haptics generator receives signals from touch detector/processor(s) 310 and/or application system 302 and drives haptics actuator(s) 352 and/or 354 to provide haptic feedback for a user. For simplicity, only some portions of system 300 are shown. For example, only two haptics actuators 352 and 354 are shown, but more may be present.

Touch surface 320 is a surface on which touch inputs are desired to be detected. For example touch surface may include the display of a mobile phone, the touch screen of a laptop, a side or an edge of a smartphone, a back of a smartphone (i.e. opposite from the display), a portion of the frame of the device or other surface. Thus, touch surface 320 is not limited to a display. Force sensors 312 and 314 may be integrated sensors including multiple strain sensors, such as integrated sensor 200. In other embodiments, force sensors 312 and 314 may be individual strain sensors. Other force sensors may also be utilized. Although two force sensors 312 and 314 are shown, another number is typically present. Touch sensors 330 and 332 may be piezoelectric sensors. Transmitter 330 may also be a piezoelectric device. In some embodiments, touch sensors 330 and 332 and transmitter 330 are interchangeable. Touch sensors 330 and 332 may be considered receivers of an ultrasonic wave transmitted by transmitter 330. In other cases, touch sensor 332 may function as a transmitter, while transmitter 330 and touch sensor 334 function as receivers. Thus, a transmitter-receiver pair may be viewed as a touch sensor in some embodiments. Multiple receivers share a transmitter in some embodiments. Although only one transmitter 330 is shown for simplicity, multiple transmitters may be used. Similarly, although two touch sensors 332 and 334 are shown, another number may be used. Application system 302 may include the processor(s) such as the central processing unit and operating system for the device in which system 300 is used.

In some embodiments, touch detector/processor(s) 310 is integrated in an integrated circuit chip. Touch detector/processor(s) 310 includes one or more microprocessors that process instructions and/or calculations that can be used to program software/firmware and/or process data for touch detector/processor(s) 310. In some embodiments, touch detector/processor(s) 310 include a memory coupled to the microprocessor and configured to provide the microprocessor with instructions. Other components such as digital signal processors may also be used.

Touch detector/processor(s) 310 receives input from force sensors 312 and 314, touch sensors 332 and 334 and, in some embodiments, transmitter 330. For example, touch detector/processor(s) 310 receives force (e.g. strain) measurements from force sensors 312 and 314, touch (e.g. piezoelectric voltage) measurements from touch sensors 332 and 334. Although termed “touch” measurements, such measurements may also be considered a measure of force. Touch detector/processor(s) 310 may also receive temperature measurements from onboard temperature sensors for force sensors 312 and/or 314, such as temperature sensor 250. Touch detector/processor(s) 310 may also obtain temperature data from one or more separate, dedicated temperature sensor(s). Touch detector/processor(s) 310 may provide signals and/or power to force sensors 312 and 314, touch sensors 332 and 334 and transmitter 330. For example, touch detector/processor(s) 310 may provide the input voltage(s) to force sensors 312 and 314, voltage or current to touch sensor(s) 332 and 334 and a signal to transmitter 330. Touch detector/processor(s) 310 utilizes the force (strain) measurements and/or touch (piezoelectric) measurements to determine whether a user has provided touch input touch surface 320. If a touch input is detected, touch detector/processor(s) 310 provides this information to application system 302 and/or haptics generator 350 for use.

Signals provided from force sensors 312 and 314 are received by touch detector/processor(s) 310 and may be conditioned for further processing. For example, touch detector/processor(s) 310 receives the strain measurements output by force sensors 312 and 314 and may utilize the signals to track the baseline signals (e.g. voltage, strain, or force) for force sensors 312 and 314. Strains due to temperature may also be accounted for by touch detector/processor(s) 310 using signals from a temperature sensor, such as temperature sensor 250. Thus, touch detector/processor(s) 310 may obtain absolute forces (the actual force on touch surface 320) from force sensors 312 and 314 by accounting for temperature. In some embodiments, a model of strain versus temperature for force sensors 312 and 314 is used. In some embodiments, a model of voltage or absolute force versus temperature may be utilized to correct force measurements from force sensors 312 and 314 for temperature.

In some embodiments, touch sensors 332 and 334 sense touch via a wave propagated through touch surface 320, such as an ultrasonic wave. For example, transmitter 330 outputs such an ultrasonic wave. Touch sensors 332 and 334 function as receivers of the ultrasonic wave. In the case of a touch by a user, the ultrasonic wave is attenuated by the presence of the user's finger (or other portion of the user contacting touch surface 320). This attenuation is sensed by one or more of touch sensors 332 and 334, which provide the signal to touch detector/processor(s) 310. The attenuated signal can be compared to a reference signal. A sufficient difference between the attenuated signal and the reference signal results in a touch being detected. The attenuated signal corresponds to a force measurement. Because the attenuation may also depend upon other factors, such as whether the user's is wearing a glove, such force measurements from touch sensors may be termed imputed force measurements. In some embodiments, absolute forces may be obtained from the imputed force measurements. As used herein in the context of touch sensors, imputed force and force may be used interchangeably.

Encoded signals may be used in system 300. In some embodiments, transmitter 330 provides an encoded signal. For example, transmitter 330 may use a first pseudo-random binary sequence (PRBS) to transmit a signal. If multiple transmitters are used, the encoded signals may differ to be able to discriminate between signals. For example, the first transmitter may use a first PRBS and the second transmitter may use a second, different PRBS which creates orthogonality between the transmitters and/or transmitted signals. Such orthogonality permits a processor or sensor coupled to the receiver to filter for or otherwise isolate a desired signal from a desired transmitter. In some embodiments, the different transmitters use time-shifted versions of the same PRBS. In some embodiments, the transmitters use orthogonal codes to create orthogonality between the transmitted signals (e.g., in addition to or as an alternative to creating orthogonality using a PRBS). In various embodiments, any appropriate technique to create orthogonality may be used. In some embodiments, encoded signals may also be used for force sensors 312 and 314. For example, an input voltage for the force sensors 312 and 314 may be provided. Such an input signal may be encoded using PRBS or another mechanism.

In some embodiments, only force sensors 312 and 314 may be used to detect touch inputs. In some such embodiments, drifts and other temperature effects may be accounted for using temperature sensor 250. Bending or other flexing may be accounted for using strain sensor 242. In other embodiments, only touch sensors 332 and 334 may be used to detect touch inputs. In such embodiments, touch inputs are detected based upon an attenuation in a signal from transmitter 330. However, in other embodiments, a combination of force sensors 312 and 314 and touch sensors 332 and 334 are used to detect touch inputs.

Based upon which sensor(s) 312, 314, 332 and/or 334 detects the touch and/or characteristics of the measurement (e.g. the magnitude of the force detected), the location of the touch input (i.e. the touch location) in addition to the presence of a touch input may be identified. For example, given an array of force and/or touch sensors, a location of a touch input may be triangulated based on the detected force and/or imputed force measurement magnitudes and the relative locations of the sensors that detected the various magnitudes (e.g., using a matched filter). Further, data from force sensors 312 and 314 can be utilized in combination with data from touch sensors 332 and 334 to detect touches. Utilization of a combination of force and touch sensors allows for the detection of touch inputs while accounting for variations in temperature, bending, user conditions (e.g. the presence of a glove) and/or other factors. Thus, detection of touches using system 300 may be improved.

For example, touch detector/processor(s) 310 receives force measurements from force sensors 312 and 314. Touch detector/processor(s) 310 receives imputed force measurements from touch sensors 332 and 334. Touch detector/processor(s) 310 identifies touch inputs based upon at least the imputed force measurements. In such embodiments, force measurements are utilized to calibrate one or more touch input criterion for touch sensors 332 and 223. For example, if a user is wearing a glove, the attenuation in the ultrasonic signal(s) sensed by touch sensors 332 and 334 may be reduced. Consequently, the corresponding imputed force measurements may not result in a detection of a touch input. However, force measurements from force sensors 312 and/or 314 correlated with and corresponding to the touch input of a user wearing a glove indicate a larger force than the imputed force measurements. In some embodiments, the measured forces corresponding to the output of touch sensors 332 and 334 are recalibrated (e.g. raised in this example) so that a reduced attenuation in the ultrasonic signal(s) is identified as a touch input. In some embodiments, a touch input is detected if the force meets or exceeds a threshold. Thus, the threshold for detecting a touch input using the signals from touch sensors 332 and 334 is recalibrated (e.g. decreased in this example) so that a reduced attenuation in the ultrasonic signal(s) is identified as a touch input. Thus, the user's condition can be accounted for. Further, touch sensors 312 and 334 may be piezoelectric sensors and thus insensitive to bends and temperature. Consequently, such effects may not adversely affect identification of touch inputs. In embodiments in which both force and imputed force measurements are used in identifying a touch input, only if force measurements from force sensors (e.g. strains indicating an input force at a particular time and location) and imputed force measurements (e.g. piezoelectric signals indicating an input force at a corresponding time and location) are sufficiently correlated. In such embodiments, there may be a reduced likelihood of bends or temperature effects resulting in a touch input being detected. The touch input criterion/criteria may then be calibrated as described above.

Thus, using system 300, touch inputs may be detected. If both force and imputed force measurements (e.g. strain and piezoelectric measurements), issues such as changes in temperature and bending of the touch surface may not adversely affect identification of touch inputs. Similarly, changes in the user, such as the user wearing a glove, may also be accounted for in detecting touch inputs. Further, the dynamic ranges of force sensors and touch sensors may differ. In some embodiments, piezoelectric touch sensors may be capable of sensing lighter touches than strain gauges used in force sensors. A wider variety of touch inputs may, therefore, be detected. Moreover, force and/or touch sensors may be utilized to detect touch inputs in regions that are not part of a display. For example, the sides, frame, back cover or other portions of a device may be used to detect touch inputs. Consequently, detection of touch inputs may be improved.

FIG. 3B depicts an embodiment of touch detector/processor(s) 310 including touch detection system 370 and gesture detection system 380. In some embodiments, touch detection system 370 and gesture detection system 380 are implemented using separate processors (e.g. a touch processor and a gesture processor). In some embodiments, touch detection system 370 and gesture detection system 380 may be implemented using the same processor. Touch detection system 370 detects touch inputs and the corresponding touch locations, as described above. Gesture detection system 380 is used to identify gestures. Although indicated as separate systems, in some embodiments, touch detection system 370 and gesture detection system 380 may be integrated into a single system.

In the embodiment shown, data from the sensors is provided to gesture detection system 380 by touch detection system 370. The data is from force and/or touch sensors 312, 314, 332 and 334. In some embodiments, data from transmitter 330 may also be provided. Such data includes force measurements and location data from sensors 312, 314, 332, and/or 334. Because sensor data is provided from touch detection system 370, the force measurements received at gesture detection system 380 from sensors 312, 314, 332, 334 has been processed by touch detection system 370. Thus, the force measurements provided to gesture detection system 380 may account for temperature variations, may include absolute force(s) determined from an imputed force, and/or otherwise provide an indication of the force employed by the user and which resulted in a touch input. Similarly, location data provided to gesture detection system 380 may be processed identify the location of a touch input identified by touch detection system 370 (i.e. a touch location) instead of or in addition to identifying locations of sensors providing the force measurements. In some embodiments, only the sensor data corresponding to touch inputs is provided to gesture detection system 380. For example, sensor data which corresponds to bends or results from forces that do not meet or exceed the threshold for a touch input detection are excluded from the data provided to gesture detection system 380. In some embodiments, raw data from sensors 312, 314, 332, 334, and/or 330 may be provided to gesture detection system 380. In such embodiments, the raw data may be received at gesture detection system 380 directly from sensors 312, 314, 332, 334, and/or 330. Consequently, touch detection system 370 can be bypassed.

Based on the force measurements and touch location, gesture detection system 380 can detect gestures. In some embodiments, other information related to the force measurements and touch locations is also used in gesture detection. For example, rate of change of force, rate of change of touch location (i.e. speed), a pattern of touch locations (e.g. touch locations and corresponding time data that describe a circle drawn by the user's touch inputs), and/or other analogous data may be used in determining whether a gesture has been identified.

In some embodiments, gesture detection system 380 utilizes gesture configurations to detect gestures. Such gesture configurations may be programmed into gesture detection system 380, be updated, or be set at manufacture. A gesture configuration may be encoded into digital form and communicated digitally to gesture detection system 380. The gesture configuration may be sent directly on a digital bus or line or it may be sent indirectly. In some cases, analog signaling may be used, but digital signaling in a standard format (such as may be provided by peripheral input devices to a computer) provides significant efficiency.

A gesture configuration includes characteristics of the gestures. For example, a gesture configuration may include one or more of: force threshold(s) (e.g. a minimum force corresponding to a button push), rate(s) of change of force threshold(s) (e.g. a minimum change in force per unit time at touch location(s)), touch location(s) (e.g. touch inputs at particular region(s) of touch surface 320), speed threshold(s) (e.g. a minimum rate of change of adjacent touch locations), direction(s) (e.g. up, down, right, left and/or diagonally across touch surface 320), particular patterns (e.g. circles, squares, stars, letters or other patterns) of movement of the touch inputs, and/or other characteristics. The thresholds may be absolute or relative. For example, the speed threshold may be an absolute threshold of a particular number of centimeters per second or may be a relative threshold of an increase in speed from a previous time interval. Similarly, a force threshold may be absolute (e.g. a force exceeding a specific number of Newtons) or relative (e.g. an increase in force greater than a particular fraction of a previous force). Thus, by specifying a set of parameters related to force and touch location, a gesture configuration may be provided.

To detect gestures, gesture detection system 380 compares the force measurements, touch locations and/or other related information (e.g. rate of change of force and/or rate of change of touch location) to the gesture configurations. If the combination of force measurement(s), touch location(s) and/or other information matches one or more of the gesture configurations, the corresponding gesture(s) are detected. In response to detection of gesture(s), gesture detection system 380 provides signal(s) indicating an identification of the gesture. For example, gesture detection system 380 may set particular bits, provide interrupt(s), assert a particular line corresponding to a particular gesture configuration, or otherwise identify the gesture that has been detected. Thus, gesture detection system 380 can, but need not, output other information, such as the magnitude of the force measurements.

The signal(s) from gesture detection system 380 that identify gestures are provided to other portion(s) of system 300. In some embodiments, gesture detection system 380 provides the signal(s) identifying the gesture(s) to haptics generator 350. Haptics generator 350 utilizes the signal as a control signal to activate one or more haptics actuator(s) 352 and/or 354 to generate the desired haptic feedback. For example, the gesture detected may be a button press near haptics actuator 352. In some embodiments, the corresponding signal provided to haptics generator 350 causes haptics generator 350 to activate haptics actuator 352 to mimic a click of a button push. In some embodiments, gesture detection system 380 may directly control haptics actuator(s) 352 and/or 354. In such embodiments, the signal provided by gesture detection system 380 is the driving signal used by haptics actuator(s) 352 and/or 354 for the gesture. In such embodiments, haptics generator 350 may be bypassed and/or be omitted. Gesture detection system 380 may also provide the signal(s) identifying gesture(s) application system 302 for other uses. For example, the gestures detected may be more readily used to update a user interface in response to the gesture. Moreover, gesture detection system 380 may provide the signal(s) identifying gesture(s) to other portions of system 300 or the device incorporating system 300.

In some embodiments, gesture detection system 380 can receive other external input(s). For example, gesture detection system 380 may receive input from sensor(s) 360. Thus, gesture detection system 380 may receive accelerometer input. In some such embodiments, gesture detection system 380 suspends detection of the gesture based upon the accelerometer input indicating free fall. For example, gesture detection system 380 may pause operation for three hundred milliseconds or another time interval in response to the input indicating free fall. Thus, gesture detection system 380 may also aid in protecting the haptics system and/or other portions of the device from damage due to a fall. Gesture detection system 380 may also receive external inputs from application system 302. Such external inputs may be used to provide or modify gesture configuration(s), otherwise control gesture detection system 380 and/or for other purposes.

Thus, system 300 may not only detect touch inputs and touch location, but also detect gestures. Further, the gestures identified may be used to generate haptic feedback with a reduced latency. In some embodiments, for example, the latency may be reduced by up to one hundred milliseconds, up to two hundred milliseconds, or more. As such, performance of the device incorporating the system may be improved. Further, gesture detection system 380 may respond to external inputs to provide improved configurability and protect system 300 from damage.

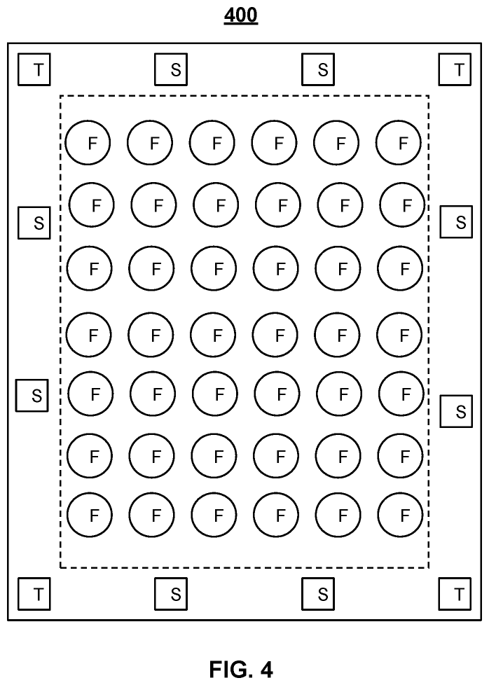

FIGS. 4-6 depict different embodiments of systems 400, 500, and 600 utilizing force and touch sensors for touch input detection. Force sensors, such as sensor(s) 100, 200, 312 and/or 314, are denoted by an “F”. Such force sensors are shown as circles and may be considered to be piezoresistive (e.g. strain) sensors. Such force sensors may also be considered integrated sensors that provide multiple strain measurements in various directions as well as temperature measurements. Touch sensors such as sensor(s) 332 and/or 334 are shown by an “S”. Transmitters, such as transmitter 330, are shown by a “T”. Such sensors and transmitters may be piezoelectric sensors and are shown as rectangles. As indicated above, sensor component arrangements are utilized to detect a touch input along a touch surface area (e.g., to detect touch input on a touchscreen display; a side, back or edge of a smart phone; a frame of a device, a portion of a mobile phone, or other region of a device desired to be sensitive to touch). The number and arrangement of force sensors, transmitters, and touch sensors shown in FIGS. 4-6 are merely examples and any number, any type and/or any arrangement of transmitters, force sensors and touch sensors may exist in various embodiments.

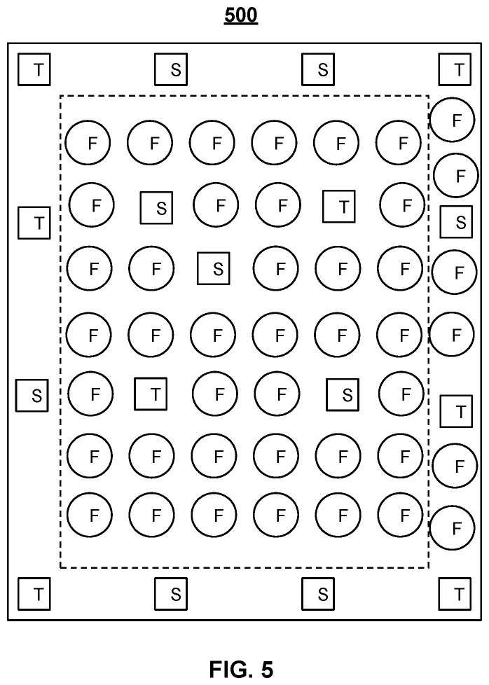

For example, in the embodiment shown in FIG. 4, device 400 includes touch sensors near the edges (e.g. along the frame) and force sensors closer to the central portion of device 400. For example, force sensors might be used along the back cover or for the display. FIG. 5 depicts another arrangement of force sensors, touch sensors and transmitters on device 500. In this embodiment, force sensors and touch sensors are used not only near the edges (e.g. on a housing), but also for a central portion, such as a display. Thus, virtually all of device 500 may be used as a touch surface.

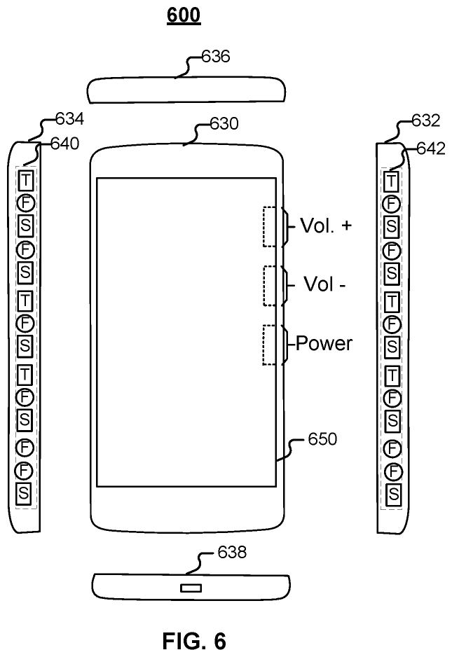

FIG. 6 is a diagram illustrating different views of device 600, a smart phone, with touch input enabled housing. Front view 630 of the device shows a front display surface of the device. Left side view 634 of the device shows an example touch surface 640 on a sidewall of the device where a touch input is able to be detected. Both touch sensors and force sensors are used to detect touches of touch surface 640. For example, a location and a force of a user touch input are able to be detected in region 640 by detecting disturbances to transmitted signals in region 640. By touch enabling the side of the device, one or more functions traditionally served by physical buttons are able to be provided without the use of physical buttons. For example, volume control inputs are able to be detected on the side without the use of physical volume control buttons. Right side view 632 of the device shows touch input external surface region 642 on another sidewall of the device where a user touch input can be detected. Although regions 640 and 642 have been shown as smooth regions, in various other embodiments one or more physical buttons, ports, and/or openings (e.g., SIM/memory card tray) may exist, or the region can be textured to provide an indication of the sensing region. Touch input detection may be provided over surfaces of physical buttons, trays, flaps, switches, etc. by detecting transmitted signal disturbances to allow touch input detection without requiring detection of physical movement/deflection of a component of the device (e.g., detect finger swiping over a surface of a physical button). In some embodiments, the touch input regions on the sides may be divided into different regions that correspond to different functions. For example, virtual volume and power buttons have been defined on right side 632. The touch input provided in region 640 (and likewise in region 642) is detected along a one-dimensional axis. For example, a touch location is detected as a position on its lengthwise axis without differentiating the width of the object touching the sensing region. In an alternative embodiment, the width of the object touching the sensing region is also detected. Regions 640 and 642 correspond to regions beneath which touch input transmitters and sensors are located. A particular configuration of force sensors (F), touch sensors (S) and transmitters (T) is shown for simplicity. Other configurations and/or other sensors may be used. Although two touch input regions on the housing of the device have been shown in FIG., other touch input regions on the housing may exist in various other embodiments. For example, surfaces on top (e.g., surface on top view 636) and/or bottom (e.g., surface on bottom view 638) of the device are touch input enabled. The shapes of touch input surfaces/regions on device sidewalls (e.g., regions 640 and 642) may be at least in part flat, at least in part curved, at least in part angular, at least in part textured, and/or any combination thereof. Further, display 650 is also a touch surface in some embodiments. For simplicity, sensors are not shown in display 650. Sensors analogous to those described herein and/or other touch sensors may be used in display 650.

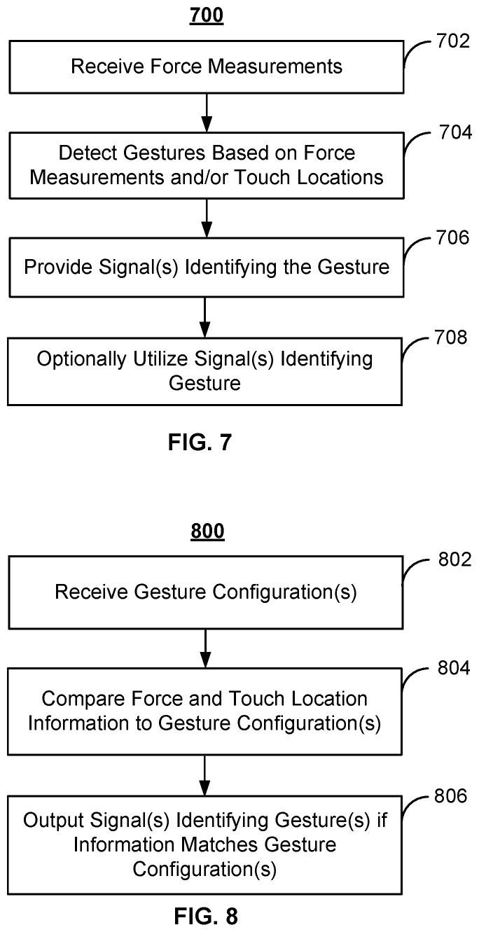

Utilizing force measurements from force and/or touch sensors, a user interface may be better controlled. FIG. 7 is a flow chart depicting an embodiment of method 700 for using touch and/or force sensors and for detecting gestures. In some embodiments, processes of method 700 may be performed in a different order, including in parallel, may be omitted and/or may include substeps.

Force measurements are received from sensors, at 702. In some embodiments, the force measurements are received from force and/or touch sensors. Also at 702, locations corresponding to the force measurements are received or otherwise determined. In some embodiments, the force measurements and touch locations received are for touch inputs that have been identified. Thus, in some embodiments, the force measurements are received from a touch detection system. In some embodiments, the force measurements are received directly from the sensors.

Based on the force measurements and touch location(s), gestures are detected, at 704. In some embodiments, other information related to the force measurements and touch locations is also used in gesture detection. For example, rate of change of force, rate of change of touch location (i.e. speed), a pattern of touch locations, and/or other analogous data may be used in detecting gestures. These quantities may be calculated from the force measurements and touch location(s) received at 702.

In response to a gesture being detected, one or more signals that identify the gesture are output, at 706. In some embodiments, a particular line asserted, a combination of bits set, or other information identifies the gesture. For example, the signal(s) may identify a particular button being pushed, a particular slide bar being activated, a user tracing a particular shape (e.g. a circle or a square) on the touch surface, and/or another gesture. Although the signals provided at 706 identify the gestures, the signal(s) need not include data for the gesture or otherwise describe the gesture. For example, if four gestures are capable of being recognized, then at 706, information identifying Gesture 1, Gesture 2, Gesture 3 or Gesture 4 may be output. In some embodiments, for example, a first line may be asserted if Gesture 1 is detected, a second line may be asserted if Gesture 2 is detected, a third line may be asserted if Gesture 3 is detected and a fourth line may be asserted if Gesture 4 is detected. The magnitude of the forces, the coordinates or other descriptors for the touch location, any rates of change of the force and/or other data used in identifying the gesture can but need not be output.

The signals identifying the gestures may utilized by the device, at 708. For example, haptic feedback may be provided, graphical and other user interfaces may be updated, and other actions may be taken.

For example, gesture detection system 380 may receive force measurements at 702 from touch detection system 370 or directly from sensors 312, 314, 332 and/or 334. Thus, raw or processed data may be received. In some embodiments, processed force and other data only for identified touch inputs is received at 702. In such embodiments, less additional conditioning of data may be performed by gesture detection system 380. In some embodiments, related quantities, such as the rate of change of force and/or the rate of change of touch location (i.e. speed) may be received at 702. In some embodiments, such quantities are determined by gesture detection system 380. Based on the force measurements and touch location(s) received, gesture detection system 380 detects gesture(s) that have been previously identified to gesture detection system 380. Signal(s) identifying the detected gestures are output by gesture detection system 380, at 706. These identified gestures may then be utilized, for example for controlling haptics generator 350 and/or by application system 302 for updating the status of the device.

Thus, using method 700, gestures can be detected and utilized in a device. Consequently, performance of the device may be improved. For example, the signal(s) identifying the gestures can be provided directly to haptics generator 350 or an analogous component to generate haptic or other feedback. Consequently, latency can be reduced and user experience improved.

FIG. 8 is a flow chart depicting an embodiment of method 800 for detecting gestures. In some embodiments, processes of method 800 may be performed in a different order, including in parallel, may be omitted and/or may include substeps. Method 800 may be considered to be one technique for accomplishing processes 704 and 706 of method 700.

Gesture configurations are received, at 802. In some embodiments, receiving gesture configurations at 802 is temporally decoupled from the remainder of method 800. Thus, gesture configurations may be received at manufacture, upon installation of particular applications, upon updating the device and/or at other times that may be convenient. A gesture configuration includes characteristics of the gestures such as force threshold(s), thresholds for rate(s) of change of force, touch location(s), speed threshold(s), direction(s), particular patterns of movement of the touch inputs, and/or other characteristics. The thresholds may be absolute or relative. Thus, sets of parameters related to force and touch location and that describe a gesture are provided in the gesture configuration. In some embodiments, 802 includes not only receiving the initial gesture configurations, but also receiving new gesture configurations and updates to the gesture configurations previously received.

The force measurements, touch locations and/or other related information (e.g. rate of change of force and/or rate of change of touch location) are compared to the gesture configurations, at 804. If a match for one or more of the gesture configurations, the corresponding gesture(s) are detected at 804. In response to detection of gesture(s), signal(s) indicating an identification of the gesture(s) are output, at 806.

For example, gesture detection system 380 may receive gesture configurations from application system 302 at 802. In addition to the description of the characteristics of the gesture, the gesture configuration received at 802 can specify the signal(s) identifying the gesture. For example, the lines to be asserted and/or bits to be set may be provided to gesture detection system 380.

At 804, gesture detection system 380 compares the force measurements, touch locations and/or other information to the gesture configurations that have been received. Thus, at 804 gesture detection system 380 detects a gesture if a match for the corresponding gesture configuration is identified. The output signal that identifies the detected gesture is output, at 806. For example, the output signal might be transmitted to haptics generator 350, application system 302 and/or other portions of the device. In some embodiments, for at least some gestures, the gesture configuration indicates that data is also to be output. For example, the magnitude of the force may be required to be output for some gesture(s). In such cases, additional data is provided at 804. In other cases, however, only the signal(s) identifying the gesture are output at 804.

Thus, using method 800, the gestures detectable by the system, such as system 300 may be specified and updated. Gestures may be efficiently recognized and signals identifying the gestures may be output for use. Consequently, performance of the device may be improved.

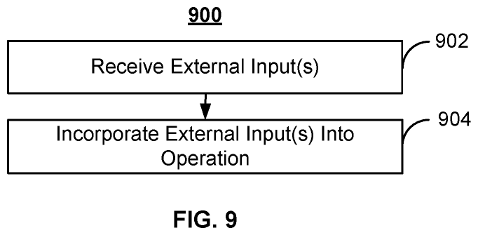

FIG. 9 is a flow chart depicting an embodiment of method 900 for detecting gestures. In some embodiments, processes of method 900 may be performed in a different order, including in parallel, may be omitted and/or may include substeps.

External input(s) are received, at 902. For example, gesture configurations may be received from an outside source, accelerometer data may be received from an outside accelerometer, and ambient temperature may be received from a temperature sensor and/or other information. Such external input(s) are incorporated into operation of the system, at 904.

For example, gesture detection system 380 may receive accelerometer data from sensor(s) 360, at 902. Gesture detection system 380 suspends operation in response to the accelerometer input indicating free fall. Thus, the processor may also aid in protecting the haptics system and/or other portions of the device from damage due to a fall.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a plurality of sensors configured to sense force; and
a processor configured to:
receive a plurality of force measurements from the plurality of sensors, the plurality of force measurements corresponding to a plurality of touch locations;
detect a gesture based on the plurality of force measurements and the plurality of touch locations; and
provide at least one signal indicating an identification of the gesture.

2. The system of claim 1, wherein the processor is configured to:
receive a gesture configuration identifying a plurality of characteristics for the gesture.

3. The system of claim 2, wherein the plurality of characteristics include at least one of a is force, a touch location, a speed, and a pattern of touch locations.

4. The system of claim 3, wherein the force includes at least one of a force threshold and a rate of change of force threshold.

5. The system of claim 3, wherein the touch location includes a plurality of locations defining at least one region of at least one touch surface.

6. The system of claim 3, wherein the speed includes at least one of an absolute speed threshold and a relative speed threshold.

7. The system of claim 3, wherein the pattern of touch locations include at least one of a geometric shape and a direction across at least a portion of at least one touch surface.

8. The system of claim 1, further comprising:
at least one haptics generator, the processor being configured to provide the at least one signal to the at least one haptics generator.

9. The system of claim 1, wherein the processor configured to provide the at least one signal to an applications processing unit of a device incorporating the processor.

10. The system of claim 1, wherein the processor is further configure to receive at least one external input.

11. The system of claim 10, wherein the external input is an accelerometer input and wherein the processor is further configured to:
pause detection of the gesture based upon the at least one external input indicating free fall.

12. The system of claim 1, wherein the plurality of sensors include at least one of a touch sensor and a force sensor.

13. A method, comprising:
receiving a plurality of force measurements from a plurality of sensors, the plurality of force measurements corresponding to a plurality of touch locations;
detecting a gesture based on the plurality of force measurements and the plurality of touch locations; and
providing at least one signal indicating an identification of the gesture.

14. The method of claim 13, further comprising:
receiving a gesture configuration identifying a plurality of characteristics for the gesture.

15. The method of claim 14, wherein the plurality of characteristics include at least one of a force, a touch location, a speed, and a pattern of touch locations.

16. The method of claim 15, wherein at least one of the force includes at least one of a force threshold and a rate of change of force threshold, the touch location includes a plurality of locations defining at least one region of at least one touch surface, the speed includes at least one of an absolute speed threshold and a relative speed threshold, and the pattern of touch locations include at least one of a geometric shape and a direction across at least a portion of at least one touch surface.

17. The method of claim 13, wherein the providing the at least one signal further includes:
providing the at least one signal to at least one haptics generator.

18. The method of claim 13, wherein the providing the at least one signal further includes:
providing the at least one signal to an applications processing unit.

19. The method of claim 13, further comprising:
receiving at least one external input.

20. The method of claim 19, wherein the external input is an accelerometer input and wherein the method further includes:
pausing detection based upon the external input indicating free fall.
